(19) United States
(12) Patent Application Publication
(10) Pub. No.: US 2013/0226663 A1
(43) Pub. Date: Aug. 29, 2013

(54) SYSTEMS AND METHODS FOR PROVIDING INTER-MARKET COLLABORATIVE SERVICES USING SOCIAL NETWORKS

(71) Applicants: Sonia Jahid, Champaign, IL (US); Yu-An Sun, Webster, NY (US)

(72) Inventors: Sonia Jahid, Champaign, IL (US); Yu-An Sun, Webster, NY (US)

(73) Assignee: Xerox Corporation, Norwalk, CT (US)

(21) Appl. No.: 13/408,230

(22) Filed: Feb. 29, 2012

(51) Int. Cl. G06Q 30/02

(52) U.S. Cl. 705/7.32

(57) ABSTRACT

Methods and systems for propagating requests for proposal via a collaborative services framework are provided. The methods include receiving a request for proposal from a first user in a first market that implements at least one peer node in the collaborative services framework and maintains lists of market neighbors and potential neighbors. The methods further include propagating the request for proposal to potential neighboring markets that are selected from a list of potential neighbors of the first market. The methods also include receiving a notification that the first user has accepted a bid from a second user responsive to the request for proposal, the second user being in a second market different from the first market, and then updating the lists of market neighbors and potential neighbors of the first market based on the accepted bid.

### TECHNICAL FIELD

The subject matter of this disclosure relates to collaborative services. More particularly, the subject matter of this disclosure relates to techniques and platforms that use a distributed social network to provide collaborative services to users in discrete online markets.

### BACKGROUND

The rapid growth in the past decade of social networking sites, such as Facebook and LinkedIn, has revealed a prominent trend of Internet usage. Social networking generally relates to services and tools that help users maintain and expand their circles of friends usually by exploiting existing relationships. Social networking sites have become places on the Internet where many people spend most of their time, thus making these sites a main entry point for online activity. Oftentimes, these social networking sites can become the focal point for sharing information, such as links, multimedia, music, and the like.

Presently, online labor markets and other topical markets generally operate as isolated sites that do not effectively communicate with one another, if at all. For example, jobs and bids posted on one site are viewable only by users who belong to that particular site. A problem associated with the process of enabling communication among different market sites is how a social networking system can be created in the absence of dedicated infrastructure. Another problem is how the social networking system can enable new market features, such as allowing advertisement of job postings on various market sites using the social networking system.

Accordingly, it may be desirable to have methods and systems that provide a social network to connect users in various discrete markets and facilitate the users in advertising and bidding on job postings across the discrete markets.

### SUMMARY

According to various embodiments, the present teachings include a collaborative services framework that uses a social network to propagate requests for proposal. Embodiments of the present invention implement the collaborative services framework in a peer-to-peer distributed manner, to provide social networking features to users in discrete markets such as online labor markets and other topical markets. The collaborative services framework can include a social network overlay and a market similarity overlay. The social network overlay can create and manage social links between users in the same market or different markets, and the collaborative services framework can propagate a request for proposal from a user to other users based on the social links. The market similarity overlay can dynamically link markets that are determined to be similar based on interactions and/or social links between users in the markets, and the collaborative services framework can propagate a request for proposal from a user in a first market to other markets that are potential neighbors of the first market. Using the social network overlay and/or the market similarity overlay, the collaborative services framework provides an advertising mechanism through which a user in a market can propagate requests for proposal to users in other markets based on their past working relationships.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

The accompanying drawings, which are incorporated in and constitute a part of this specification, illustrate embodiments of the invention and together with the description, serve to explain the principles of the invention. In the figures:

FIG. 1 illustrates an exemplary collaborative services system, in accordance with embodiments of the present teachings;

FIGS. 2 and 3 illustrate flowcharts of processing performed by an exemplary collaborative services system to provide inter-market collaborative services using social networks, according to embodiments of the present teachings; and

FIG. 4 illustrates a computer system that is consistent with embodiments of the present teachings.

### DESCRIPTION OF THE EMBODIMENTS

For simplicity and illustrative purposes, the principles of the present teachings are described by referring mainly to exemplary embodiments thereof. However, one of ordinary skill in the art would readily recognize that the same principles are equally applicable to, and can be implemented in, all types of networking systems, and that any such variations do not depart from the true spirit and scope of the present invention. Moreover, in the following detailed description, references are made to the accompanying figures, which illustrate specific embodiments. Electrical, mechanical, logical and structural changes can be made to the embodiments without departing from the spirit and scope of the present invention. The following detailed description is, therefore, not to be taken in a limiting sense and the scope of the present invention is defined by the appended claims and their equivalents.

Embodiments of the present invention implement a collaborative services framework in a peer-to-peer (“P2P”) distributed manner, to provide social networking features to users in discrete markets such as online labor markets and other topical markets. The collaborative services framework can provide one or more overlays implemented on top of the markets, without requiring modification to existing software and infrastructure used to implement the markets.

In various embodiments, the collaborative services framework can include a social network overlay and a market similarity overlay. The social network overlay can create and manage social links between users in the same market or different markets, and can propagate at least one request for proposals (“RFP”) from a user to other users based on the social links. The social network overlay can dynamically create and update social links between users based on interactions between the users as well as the number, frequency, age, and other attributes of the interactions. The market similarity overlay can dynamically link markets that are determined to be similar based on interactions and/or social links between users in the markets. For each market, the market similarity overlay can create and manage lists of market neighbors and potential neighbors, and can dynamically update the lists based on interactions between users in that market and users in other markets. The market neighbors list of a market can include other markets with which that market has had at least one direct interaction. The potential neighbors list of a market can include other markets that the market has not directly interacted with but is likely to do so in the future. Using the social network overlay and/or the market similarity overlay, the collaborative services framework provides an advertising mechanism through which a user in a market can propagate RFPs to users in other markets based on their past working relationships.

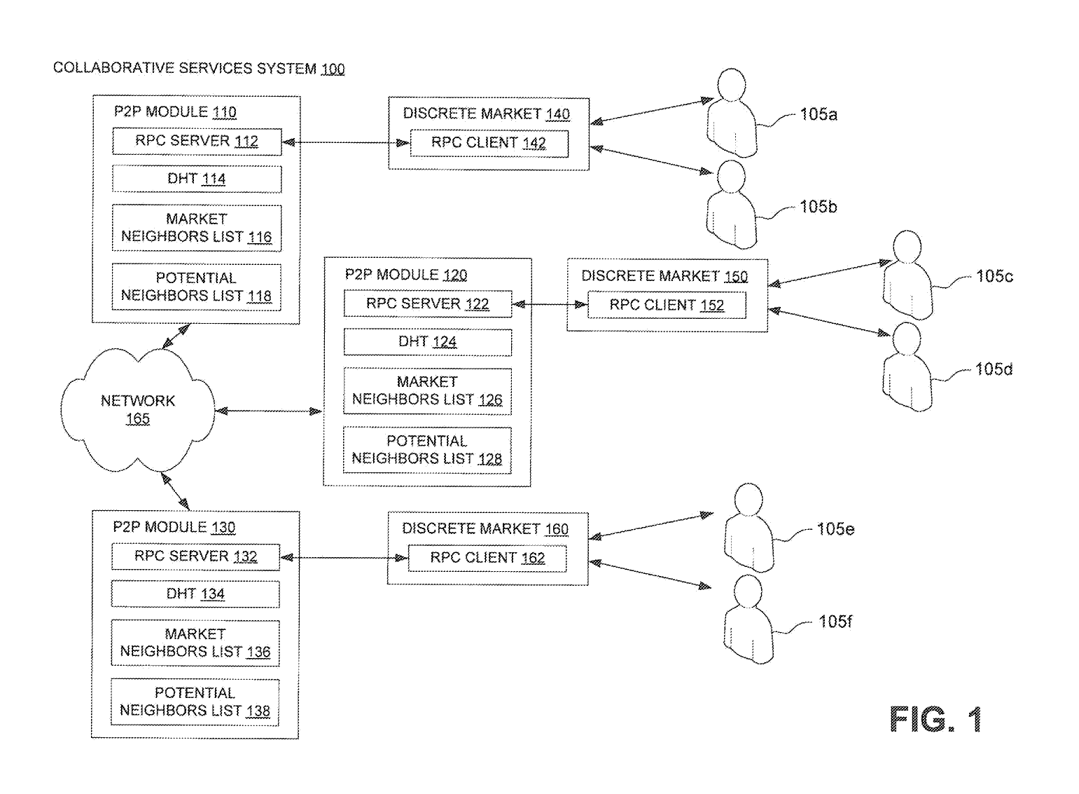

FIG. 1 illustrates an exemplary embodiment of a collaborative services system 100 that utilizes a distributed social network to provide inter-market collaborative services, in a manner consistent with the principles of the present invention. As shown, collaborative services system 100 can include P2P modules (e.g., P2P modules 110, 120, and 130) communicatively coupled to participating discrete markets (e.g., discrete markets 140, 150, and 160), respectively, via remote procedure call servers (e.g., RPC servers 112, 122, and 132) and clients (e.g., RPC clients 142, 152, and 162) or other inter-process communication mechanisms known to one skilled in the art. The P2P modules can be communicatively coupled to each other via one or more networks 165, such as a local area network, a wide area network, the Internet, a cloud-based network, a cellular network, a combination thereof, and the like.

In various embodiments, collaborative services system 100 can be implemented independently from the discrete markets and can provide one or more network overlays on top of the discrete markets. Each discrete market can use an RPC client running therein to communicate with an RPC server running in the P2P module corresponding to that discrete market. The discrete markets and their corresponding P2P modules can be communicative coupled via a direct connection or one or more networks (not shown), such as a local area network, a wide area network, the Internet, a cloud-based network, a cellular network, a combination thereof, and the like. The discrete markets can use the RPC clients to send queries or events to collaborative services system 100. An event can include, for example, a user posting an RFP, a user making a bid responsive to an RFP, a user accepting a bid responsive to an RFP (i.e., a user awarding a bid), a user providing a rating or feedback on a transaction (as described infra), and the like.

Collaborative services system 100 can leverage a distributed hash table (e.g., DHTs 114, 124, and 134) to form a social network overlay, with each of the discrete markets forming a node in the social network overlay. The DHT serves as a distributed database that can be distributed across the discrete markets participating in collaborative services system 100. The DHT can manage objects of the social network overlay, such as contact lists that represent a network of users (e.g., users 105a-f) in the discrete markets. The discrete markets are each shown to include or host two users for illustrative purposes only. In various embodiments, each of the discrete markets can include or host any number of users.

The DHT can store a list of connections, such as social links, between pairs of users based on the users' past interactions. A social link between a pair of users can include the users' identifiers, a list of one or more interactions between the users, and a strength of the social link. An interaction can include a transaction or a feedback on a transaction, the feedback including, for example, a user-entered rating for the transaction. A transaction transpires when a poster, or the user that posted an RFP, accepts a bid from a bidder, or the user that made the bid in response to the RFP, i.e., the poster assigns or awards the bid to the bidder. Different types of interactions are possible between a pair of users, including, for example, internal and external. An interaction can be classified as internal if the poster and the bidder are from the same market, and as external if the poster and the bidder are from different markets.

A social link's strength can be determined and/or updated based on the number, frequency, and/or age of interactions associated with the social link, ratings on one or more transactions associated with the social link, and the like. For example, collaborative services system 100 can determine the strength of a social link between a pair of users based on an exponential average of the ratings and the frequency of interactions between the pair of users in a specific time period under consideration. In various embodiments, the strength of a social link can be computed using formulas (1)-(3):

$$\begin{matrix}f ( w ) = β \cdot g ( w ) + ( 1 - β ) \cdot h ( w ) , where β ∈ ( 0 , 1 ) & ( 1 ) \\ g ( w ) = min ( 1 , \frac{{n}_{intr}}{{n}_{w}} ) & ( 2 ) \\ h ( w ) : {g}_{t} = α \cdot {r}_{t - 1} + ( 1 - α ) \cdot {g}_{t - 1} , where α ∈ ( 0 , 1 ) & ( 3 )\end{matrix}$$

As shown in formula (1), a link strength f(w) for a time window w is a function of an interaction frequency g(w) and an average rating h(w) of transactions associated with the social link. The interaction frequency g(w), as shown in formula (2), is a function of the number of interactions nᵢₙₜᵣ in the time window w and the number of days n_{w} in the time window. The average rating h(w), as shown in formula (3), is an exponential moving average of the ratings associated with the social link. For formulas (1)-(3), α and β are system parameters, rₜ is the rating at time t, and gₜ is the average of the ratings up to time t. As shown, the values of formulas (1)-(3) can be normalized to 1.

In various embodiments, collaborative services system 100 can also leverage the P2P modules to form a market similarity overlay, to dynamically link discrete markets that are determined to be similar based on interactions and/or social links between users in those discrete markets. For each discrete market, the market similarity overlay can create and manage a list of market neighbors (e.g., market neighbors lists 116, 126, and 136) and a list of potential neighbors (e.g., potential neighbors lists 118, 128, and 138), and can dynamically update the lists based on interactions between users in that discrete market and users in other discrete markets. The lists of market neighbors and potential neighbors of a discrete market can be mutually exclusive, i.e., markets in the list of market neighbors would not be in the potential neighbors list, and vice versa.

The market neighbors list of a discrete market can include other discrete markets with which the discrete market has had at least one direct interaction. More particularly, for each participating discrete market Mᵢ, collaborative services system 100 can keep a list of up to log(N) neighboring markets, where N is the total number of discrete markets participating in collaborative services system 100. The discrete markets in the market neighbors list can be considered neighbors of Mᵢ. The market neighbors list of Mᵢ can be empty initially. When an external interaction involving a first user in Mᵢ and a second user in another discrete market Mⱼ transpires, collaborative services system 100 can establish a market link between markets M, and Mⱼ, if one does not exist, by adding Mⱼ to the market neighbors list of Mᵢ. Collaborative services system 100 can also add Mᵢ to a market neighbors list of Mⱼ. A market link between a pair of discrete markets can include the markets' identifiers, a list of one or more external interactions between users in the markets, and a strength of the market link.

A market link's strength can be determined and/or updated based on the number, frequency, and/or age of external interactions associated with the market link, ratings on one or more external transactions associated with the market link, and the like. Collaborative services system 100 can update the strength of market links on a periodic basis and/or when an external interaction transpires. The strength of a market link between a pair of discrete markets can be determined based on an exponential average of the ratings of external transactions and the frequency of external interactions between users in the pair of discrete markets in a specific time period under consideration. For example, collaborative services system 100 can dynamically strengthen a market link between discrete markets Mᵢ and Mⱼ based on an increased number or frequency of external interactions between users in Mᵢ and Mⱼ and/or positive ratings for external transactions associated with the market link. Alternatively, collaborative services system 100 can dynamically weaken the market link based on a decreased number or a lack of external interactions between users in Mᵢ and Mⱼ over consecutive time periods and/or negative ratings for external transactions associated with the market link. In various embodiments, the strength of a market link can be computed using formulas (4)-(6):

$$\begin{matrix}F ( w ) = χ \cdot G ( w ) + ( 1 - χ ) \cdot H ( w ) , where χ ∈ ( 0 , 1 ) & ( 4 ) \\ G ( w ) = min ( 1 , \frac{{N}_{x}}{{N}_{w}} ) & ( 5 ) \\ H ( w ) : {g}_{t} = δ \cdot {r}_{t - 1} + ( 1 - δ ) \cdot {g}_{t - 1} , where δ ∈ ( 0 , 1 ) & ( 6 )\end{matrix}$$

As shown in formula (4), a link strength F(w) for a time window w is a function of an external interaction frequency G(w) and an average rating H(w) of external transactions associated with the market link. The external interaction frequency G(w), as shown in formula (5), is a function of the number Nₓ of external interactions between users in the pair of discrete markets in the time window w, and the number of days N_{w} in the time window. The average rating H(w), as shown in formula (6), is an exponential moving average of the ratings of external transactions associated with the market link. For formulas (4)-(6), δ and χ are system parameters, rₜ is the rating at time t, and gₜ is the average of the ratings up to time t. As shown, the values of formulas (4)-(6) can be normalized to 1.

The potential neighbors list of a discrete market can include other discrete markets that the discrete market has not directly interacted with, but there is a probability that an external interaction could transpire between users in those markets in the future. The probability for a discrete market and a potential market neighbor can be determined based on, for example, an aggregate or an average of path strengths between users in those markets and users in one or more common market neighbors shared by those markets. More particularly, for each participating discrete market Mᵢ, collaborative services system 100 can keep a list of log(N) potential neighbors, where N is the total number of discrete markets participating in collaborative services system 100. The potential neighbors list of Mᵢ can be randomly populated initially. In various embodiments, potential neighbors of discrete market Mᵢ and path strength to those potential neighbors can be determined using formulas (7)-(9):

$$\begin{matrix}∀ {M}_{j} ∈ neighbor ( {M}_{i} ) ∀ {M}_{k} ∈ neighbor ( {M}_{j} ) & ( 7 ) \\ {x}_{ijk} = \frac{{n}_{ij} \cdot {F}_{ij} + {n}_{jk} \cdot {F}_{jk}}{{n}_{ij} + {n}_{jk}} & ( 8 ) \\ {p}_{ik} = {∀}_{j} \frac{{x}_{ijk} \cdot {n}_{ij}}{{n}_{ij}} & ( 9 )\end{matrix}$$

On a periodic basis, discrete market Mᵢ can obtain or receive, from its strong market neighbors Mⱼ, their market neighbors Mₖ, as shown in formula (7). Strong market neighbors Mⱼ include log(N) market neighbors with the highest market link strengths. Mₖ can be considered friends of friends of Mᵢ. For discrete market Mᵢ, collaborative services system 100 can use formula (8) to determine a path strength xᵢⱼₖ to each of its potential neighbors Mₖ through its neighbors Mⱼ, if Mⱼ has Mₖ in their market neighbor list. As used in formulas (8) and (9), nᵢⱼ and nⱼₖ represent the number of interactions between pairs of markets (Mᵢ, Mⱼ) and (Mⱼ, Mₖ), respectively, and Fᵢⱼ and Fⱼₖ represent the strength of the market links between pairs of markets (Mᵢ, Mⱼ) and (Mⱼ, Mₖ), respectively. As shown in formula (9), pᵢₖ is the weighted average of all the path strengths xᵢⱼₖ from Mᵢ to Mₖ through Mⱼ. Collaborative services system 100 can use formula (9) to determine pᵢₖ for Mᵢ, and then populate the list of potential neighbors of Mᵢ with log(N) of the discrete markets Mₖ having the highest pᵢₖ.

In some cases, the size of the list of potential neighbors of Mᵢ can be less than log(N), in which case collaborative services system 100 can randomly select other discrete markets not already in the lists of market neighbors and potential neighbors of Mᵢ, and calculate a similarity score between them based on their common market neighbors. Specifically, collaborative services system 100 can use a Tanimoto coefficient to calculate the similarity score using two-bit vectors that represent their neighbors. When applied on bit vectors, the formula to calculate the Tanimoto coefficient becomes:

$${p}_{ik} = \frac{A \cdot B}{{\vert A \vert}^{2} + {\vert B \vert}^{2} - A \cdot B} \qquad ( 10 )$$

After determining and populating the list of potential neighbors of Mᵢ based on path strengths and common neighbors, if the size of the potential neighbors list of Mᵢ remains less than log(N), then collaborative services system 100 can populate the list of potential neighbors with random discrete markets with pᵢₖ=0.5.

In various embodiments, collaborative services system 100 can periodically update the strength of social links between users in collaborative services system 100. Collaborative services system 100 can also periodically update the strength of market links between discrete markets in collaborative services system 100, as well as the discrete markets' lists of market neighbor and potential neighbors. For each discrete market, collaborative services system 100 can update its market neighbors list by determining the strength of its market links, replacing weak market links with strong market links, and resizing the market neighbors list. Collaborative services system 100 can update the discrete market's potential neighbors list by monitoring bids received from discrete markets in the potential neighbors list and for any transactions that transpired between them. If at least one transaction transpires between a discrete market Mᵢ and a potential neighbor Mₖ, they can become market neighbors, and Mₖ can be removed from the potential neighbors list of M, and added to the market neighbors list of Mᵢ. On the other hand, if no bid is received from potential neighbor Mₖ over a period of time, then path strength pᵢₖ between Mᵢ and Mₖ can decrease linearly, as shown in formula (11).

pᵢₖ^{t}=λ·pᵢₖ^{t-1}, where λε(0,1) (11)

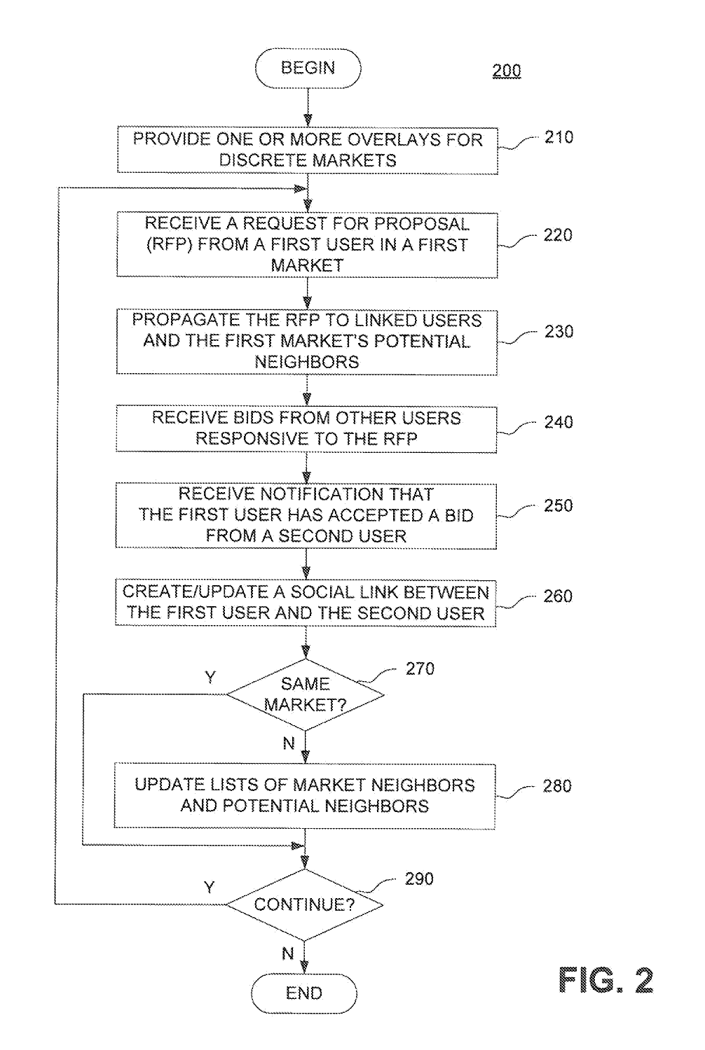

FIG. 2 illustrates a flowchart of processing 200 performed by collaborative services system 100 to provide inter-market collaborative services using social networks, according to embodiments of the present invention. Through processing 200, collaborative services system 100 can provide social networking features to users in discrete markets (e.g., discrete markets 140, 150, and 160) by providing network overlays implemented on top of the markets.

Processing 200 begins in 210, during which collaborative services system 100 can use a P2P network to provide a social network overlay and a market similarity overlay for the discrete markets participating in collaborative services system 100. By using a P2P network of P2P modules (e.g., P2P modules 110, 120, and 130) that correspond to the discrete markets, collaborative services system 100 can provide the overlays without requiring modification to existing software and infrastructure used to implement the discrete markets. Using the social network overlay, collaborative services system 100 can create and manage social links between users in the same market or different markets, and can propagate at least one RFP from a user to other users based on the social links. Social links between users can be dynamically created and updated based on interactions between the users as well as the number, frequency, age, and other attributes of the interactions. Using the market similarity overlay, collaborative services system 100 can dynamically link markets that are determined to be similar based on interactions and/or social links between users in the markets. Collaborative services system 100 can create and manage, for each of the discrete markets, a list of market neighbors and a list of potential neighbors, and can dynamically update the lists based on interactions between users in that discrete market and users in other markets. Using the social network overlay and/or the market similarity overlay, collaborative services system 100 can provide an advertising mechanism through which a user in a discrete market can propagate RFPs to users in other discrete markets based on their past working relationships.

In 220, collaborative services system 100 can receive an RFP from a first user in a first discrete market. Collaborative services system 100 can receive the RFP at a first P2P module corresponding to the first discrete market, which can include a DHT that has a list of the first user's social links and lists of market neighbors and potential neighbors of the first discrete market. A social link between the first user and a linked user can include the users' identifiers, a list of one or more interactions between the users, and a strength of the social link. An interaction can include either a transaction or a feedback/rating on a transaction. A transaction transpires when the first user that posted the RFP accepts a bid responsive to the RFP from a second user, i.e., the first user assigns or awards the bid to the second user. Different types of interactions are possible between a pair of users, including, for example, internal and external. An interaction can be classified as internal if the first user and the second user are from the same market, and as external if the first user and the second user are from different markets. The market neighbors list of the first market can include other markets with which the first market has had at least one direct interaction. The potential neighbors list can include other discrete markets that the first market has not directly interacted with but is likely to do so in the future.

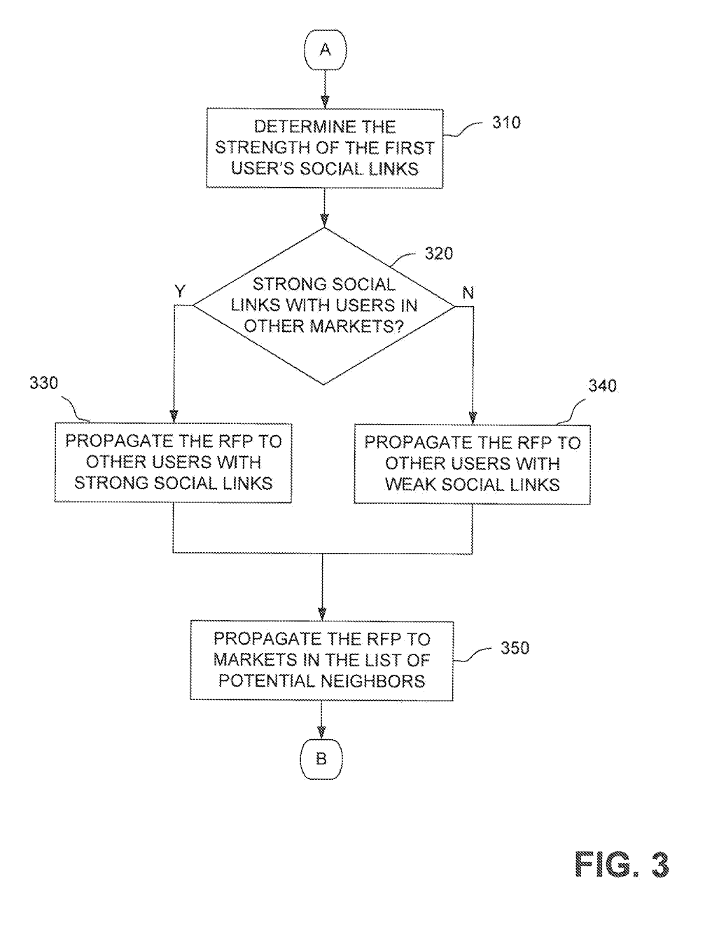

Next, in 230, collaborative services system 100 can use the first P2P module to propagate the RFP from the first user to users in other discrete markets based on the first user's social links and the first discrete market's list of potential neighbors. As shown in FIG. 3, in 310, collaborative services system 100 can determine the strength of the first user's social links. If, in 320, collaborative services system 100 determines that strong social links exist, then collaborative services system 100 can proceed to 330 and use the first P2P module to propagate the RFP from the first user to strongly linked users in other discrete markets. Otherwise, if in 320 collaborative services system 100 determines that no strong social links exist, then collaborative services system 100 can proceed to 340 and use the first P2P module to propagate the RFP from the first user to weakly linked users, if any, in other discrete markets. Next, in 350, collaborative services system 100 can use the first P2P module to propagate the RFP from the first user to discrete markets in the list of potential neighbors.

Referring back to FIG. 2, in 240, collaborative services system 100 can receive one or more bids from other users in response to the RFP from the first user, and collaborative services system 100 can use the first P2P module to forward the bids to the first user in the first discrete market. Then, in 250, collaborative services system 100 can receive a notification that the first user has accepted a bid from a second user, i.e., the first user has awarded the bid to the second user. Next, in 260, collaborative services system 100 can use the first P2P module to create a social link between the first and second users, if one does not exist, or update an existing social link between the first and second users. For example, the first P2P module can add the accepted bid to the list of interactions in the social link between the first and second users.

In 270, collaborative services system 100 can determine whether or not the first and second users are in the same discrete market. If yes, then processing 200 proceeds to 290. If no, then processing 200 proceeds to 280, in which collaborative services system 100 can use the first P2P module to update the first market's lists of market neighbors and potential neighbors and/or create or update a market link associated with the first market. For example, in 280, if collaborative services system 100 determines that the second discrete market of the second user is in the potential neighbors list of the first discrete market, then collaborative services system 100 can remove the second discrete market from the potential neighbors list of the first discrete market. Moreover, in 280, if collaborative services system 100 determines that a second discrete market of the second user is not in the market neighbors list of the first discrete market, then collaborative services system 100 can establish a market link between the first and second discrete markets by adding the second discrete market to the market neighbors list of the first discrete market; collaborative services system 100 can also add the first discrete market to the market neighbors list of the second discrete market. Furthermore, in 280, collaborative services system 100 can determine and/or update the strength of the market link between the first and second discrete markets based on the number, frequency, and/or age of external interactions between users in the first and second discrete markets, ratings on one or more external transactions between users in the first and second discrete markets, and the like. Finally, in 290, collaborative services system 100 can determines whether or not to continue processing 200. If yes, then processing 200 returns to 220; if not, then processing 200 ends.

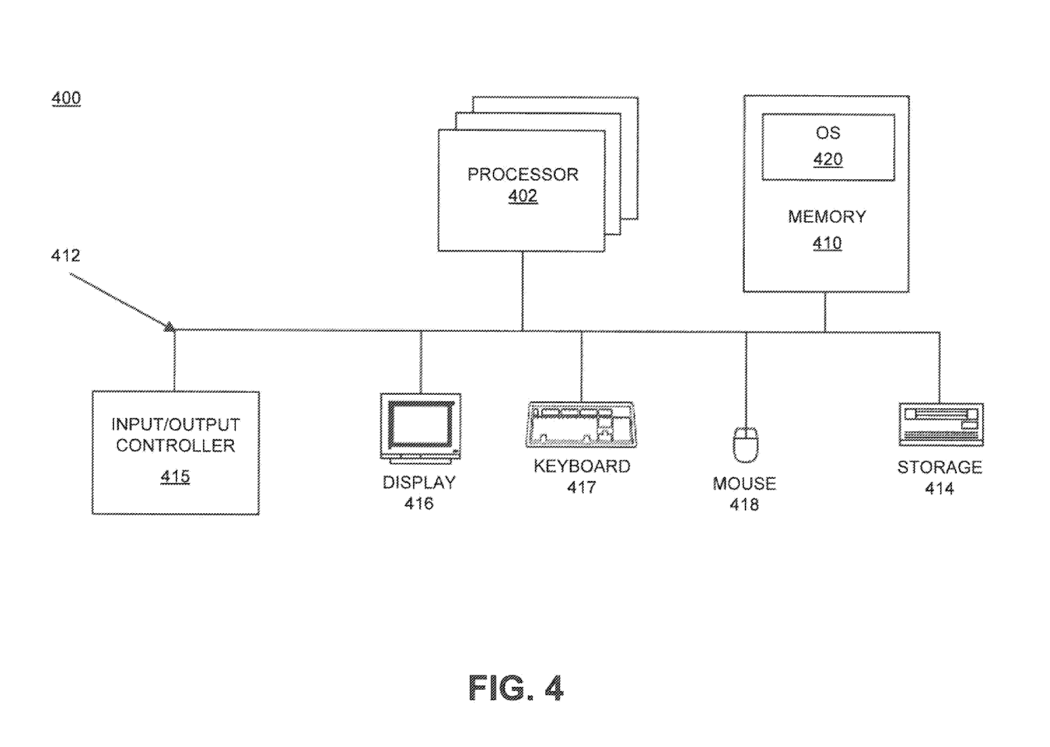

FIG. 4 illustrates a computer system 400 that is consistent with embodiments of the present teachings. In general, embodiments of a P2P module (e.g., P2P modules 110, 120, and 130) in collaborative services system 100 may be implemented in various computer systems, such as a personal computer, a server, a workstation, an embedded system, or a combination thereof, for example, computer system 400. Certain embodiments of the P2P module may be embedded as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. However, for purposes of explanation, system 400 is shown as a general purpose computer that is well known to those skilled in the art. Examples of the components that may be included in system 400 will now be described.

As shown, system 400 may include at least one processor 402, a keyboard 417, a pointing device 418 (e.g., a mouse, a touchpad, and the like), a display 416, main memory 410, an input/output controller 415, and a storage device 414. Storage device 414 can comprise, for example, RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. A copy of the computer program embodiment of the P2P module can be stored on, for example, storage device 414. System 400 may also be provided with additional input/output devices, such as a printer (not shown). The various components of system 400 communicate through a system bus 412 or similar architecture. In addition, system 400 may include an operating system (OS) 420 that resides in memory 410 during operation. One skilled in the art will recognize that system 400 may include multiple processors 402. For example, system 400 may include multiple copies of the same processor. Alternatively, system 400 may include a heterogeneous mix of various types of processors. For example, system 400 may use one processor as a primary processor and other processors as co-processors. For another example, system 400 may include one or more multi-core processors and one or more single core processors. Thus, system 400 may include any number of execution cores across a set of processors (e.g., processor 402). As to keyboard 417, pointing device 418, and display 416, these components may be implemented using components that are well known to those skilled in the art. One skilled in the art will also recognize that other components and peripherals may be included in system 400.

Main memory 410 serves as a primary storage area of system 400 and holds data that is actively used by applications, such as the P2P module of collaborative services system 100, running on processor 402. One skilled in the art will recognize that applications are software programs that each contains a set of computer instructions for instructing system 400 to perform a set of specific tasks during runtime, and that the term “applications” may be used interchangeably with application software, application programs, and/or programs in accordance with embodiments of the present teachings. Memory 410 may be implemented as a random access memory or other forms of memory as described below, which are well known to those skilled in the art.

OS 420 is an integrated collection of routines and instructions that are responsible for the direct control and management of hardware in system 400 and system operations. Additionally, OS 420 provides a foundation upon which to run application software. For example, OS 420 may perform services, such as resource allocation, scheduling, input/output control, and memory management. OS 420 may be predominantly software, but may also contain partial or complete hardware implementations and firmware. Well known examples of operating systems that are consistent with the principles of the present teachings include MICROSOFT WINDOWS (e.g., WINDOWS CE, WINDOWS NT, WINDOWS 2000, WINDOWS XP, and WINDOWS VISTA), MAC OS, LINUX, UNIX, ORACLE SOLARIS, OPEN VMS, and IBM AIX.

The foregoing description is illustrative, and variations in configuration and implementation may occur to persons skilled in the art. For instance, the various illustrative logics, logical blocks, modules, and circuits described in connection with the embodiments disclosed herein may be implemented or performed with a general purpose processor (e.g., processor 402), a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via, various means as is known in the art.

If implemented in software, the functions may be stored on or transmitted over a computer-readable medium as one or more instructions or code. Computer-readable media includes both tangible computer storage media and communication media including any medium that facilitates transfer of a computer program from one place to another. A storage media may be any available tangible media that can be accessed by a computer. By way of example, and not limitation, such tangible computer-readable media can comprise RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and blu-ray disc where disks usually reproduce data magnetically, while discs reproduce data optically with lasers. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media. Resources described as singular or integrated can in one embodiment be plural or distributed, and resources described as multiple or distributed can in embodiments be combined. The scope of the present teachings is accordingly intended to be limited only by the following claims.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of propagating a request for proposal, comprising:
receiving a request for proposal from a first user in a first market of a plurality of discrete markets, wherein each market in the plurality of discrete markets includes a plurality of users and implements at least one peer node in a peer-to-peer network, and wherein the first market maintains a list of market neighbors and a list of potential market neighbors;
populating the list of potential neighbors of the first market to include at least one other market of the plurality of discrete markets, wherein the at least one other market is selected based on a path strength between the first market and the at least one other market through one or more common market neighbors shared by the first market and the at least one other market, wherein no user in the first market has a social link to any of users in the at least one other market, and wherein the path strength between the first market and the at least one other market is determined based on a number of interactions (i) between users in the first market and users in the one or more common market neighbors and (ii) between the users in the at least one other market and the users in the one or more common market neighbors;
propagating, using a processor, the request for proposal from the first user to potential neighboring markets of the plurality of discrete markets, wherein the potential neighboring markets are selected from the list of potential market neighbors of the first market, and wherein no user in the first market has a social link to any of users in the potential neighboring markets;
receiving a notification that the first user has accepted a bid from a second user responsive to the request for proposal from the first user, wherein the second user is in a second market in the list of potential market neighbors of the first market; and
updating the lists of market neighbors and potential market neighbors of the first market based on the accepted bid, wherein at least one of the users in the first market has a social link to at least one user in a market in the list of market neighbors.

2. The method of claim 1, wherein updating the lists of market neighbors and potential neighbors further comprises:
removing the second market from the list of potential neighbors of the first market; and
adding the second market to the list of market neighbors of the first market.

3. The method of claim 1, wherein populating the list of potential neighbors further comprises:
selecting a neighboring market from a list of market neighbors of the first market;
selecting the at least one other market from a list of market neighbors of the neighboring market.

4. (canceled)

5. (canceled)

6. The method of claim 1, wherein updating the lists of market neighbors and potential neighbors further comprises:
updating a market link between the first market and the second market, wherein the market link includes a list of one or more external interactions between at least one user in the first market and at least one user in the second market.

7. The method of claim 6, wherein updating the market link further comprises:
updating a strength F(w) of the market link for a time window w based on frequency G(w) of external interactions between the at least one user in the first market and the at least one user in the second market.

8. The method of claim 7, wherein updating the strength F(w) further comprises:
updating the strength F(w) of the market link based on an average rating H(w) of external transactions between the at least one user in the first market and the at least one user in the second market.

9. The method of claim 1, wherein updating the lists of market neighbors and potential neighbors further comprises:
updating the lists of market neighbors and potential neighbors of the second market based on the accepted bid.

10. The method of claim 1, wherein the lists of market neighbors and potential neighbors of the first market are mutually exclusive.

11. The method of claim 1, wherein receiving a notification that the first user has accepted a bid from the second user further comprises:
determining that a social link between the first user and the second user does not exist;
creating the social ink between the first user and the second user; and
updating the social link between the first user and the second user to include the bid.

12. The method of claim 1, wherein receiving a notification that the user has accepted a bid from the second user further comprises:
determining that a social link between the first user and the second user exists; and
updating the social link between the first user and the second user to include the bid.

13. A system for propagating a request for proposal, comprising:
a server configured to:
receive a request for proposal from a first user in a first market of a plurality of discrete markets, wherein each market in the plurality of discrete markets includes a plurality of users and implements at least one peer node in a peer-to-peer network, and wherein the first market maintains a list of market neighbors and a list of potential market neighbors;
populate the list of potential neighbors of the first market to include at least one other market of the plurality of discrete markets, wherein the at least one other market is selected based on a path strength between the first market and the at least one other market through one or more common market neighbors shared by the first market and the at least one other market, wherein no user in the first market has a social link to any of users in the at least one other market, and wherein the path strength between the first market and the at least one other market is determined based on a number of interactions (i) between users in the first market and users in the one or more common market neighbors and (ii) between the users in the at least one other market and the users in the one or more common market neighbors;
propagate the request for proposal from the first user to potential neighboring markets of the plurality of discrete markets, wherein the potential neighboring markets are selected from the list of potential market neighbors of the first market, and wherein no user in the first market has a social link to any of users in the potential neighboring markets;
receive a notification that the first user has accepted a bid from a second user responsive to the request for proposal from the first user, wherein the second user is in a second market in the list of potential market neighbors of the first market; and
update the lists of market neighbors and potential market neighbors of the first market based on the accepted bid, wherein at least one of the users in the first market has a social link to at least one user in a market in the list of market neighbors.

14. The system of claim 13, wherein the server is further configured to:
remove the second market from the list of potential neighbors of the first market; and
add the second market to the list of market neighbors of the first market.

15. The system of claim 13, wherein the server is further configured to:
select a neighboring market from a list of market neighbors of the first market;
select the at least one other market from a list of market neighbors of the neighboring market.

16. The system of claim 13, wherein the server is further configured to:
update a market link between the first market and the second market, wherein the market link includes a list of one or more external interactions between at least one user in the first market and at least one user in the second market.

17. A computer program product, comprising:
a non-transitory computer-readable medium storing instructions that cause a computer to propagate a request for proposal when executed by the computer, comprising:
at least one instruction for causing the computer to receive a request for proposal from a first user in a first market of a plurality of discrete markets, wherein each market in the plurality of discrete markets includes a plurality of users and implements at least one peer node in a peer-to-peer network, and wherein the first market maintains a list of market neighbors and a list of potential market neighbors;
at least one instruction for causing the computer to populate the list of potential neighbors of the first market to include at least one other market of the plurality of discrete markets, wherein the at least one other market is selected based on a path strength between the first market and the at least one other market through one or more common market neighbors shared by the first market and the at least one other market, wherein no user in the first market has a social link to any of users in the at least one other market, and wherein the path strength between the first market and the at least one other market is determined based on a number of interactions (i) between users in the first market and users in the one or more common market neighbors and (ii) between the users in the at least one other market and the users in the one or more common market neighbors;
at least one instruction for causing the computer to propagate the request for proposal from the first user to potential neighboring markets of the plurality of discrete markets, wherein the potential neighboring markets are selected from the list of potential market neighbors of the first market, and wherein no user in the first market has a social link to any of users in the potential neighboring markets;
at least one instruction for causing the computer to receive a notification that the first user has accepted a bid from a second user responsive to the request for proposal from the first user, wherein the second user is in a second market in the list of potential market neighbors of the first market; and
at least one instruction for causing the computer to update the lists of market neighbors and potential market neighbors of the first market based on the accepted bid, wherein at least one of the users in the first market has a social link to at least one user in a market in the list of market neighbors.

18. The computer program product of claim 17, wherein the non-transitory computer-readable medium further comprises:
at least one instruction for causing the computer to remove the second market from the list of potential neighbors of the first market; and
at least one instruction for causing the computer to add the second market to the list of market neighbors of the first market.

19. The computer program product of claim 17, wherein the non-transitory computer-readable medium further comprises:
at least one instruction for causing the computer to select a neighboring market from a list of market neighbors of the first market; and
at least one instruction for causing the computer to select the at least one other market from a list of market neighbors of the neighboring market.

20. The computer program product of claim 17, wherein the non-transitory computer-readable medium further comprises:
at least one instruction for causing the computer to update a market link between the first market and the second market, wherein the market link includes a list of one or more external interactions between at least one user in the first market and at least one user in the second market.
